(19) United States
(12) Patent Application Publication
(10) Pub. No.: US 2001/0038503 A1
(43) Pub. Date: Nov. 8, 2001

(54) DIFFRACTIVE OPTICAL ELEMENT AND OPTICAL SYSTEM HAVING THE SAME

(76) Inventor: TAKEHIKO NAKAI, KAWASAKI-SHI (JP)

Correspondence Address: FITZPATRICK CELLA HARPER & SCINTO, 30 ROCKEFELLER PLAZA, NEW YORK, NY, 10112, US

(21) Appl. No.: 09/241,851

(22) Filed: Feb. 2, 1999

(30) Foreign Application Priority Data
Feb. 5, 1998 (JP) HEI10-039639

(51) Int. Cl. G02B 5/10

(52) U.S. Cl. 359/869

(57) ABSTRACT

A diffractive optical element includes a pair of diffraction gratings. The pair of diffraction gratings differ in dispersion from each other and confront each other through a space of a refractive index of 1. A maximum optical path length difference occurring in the pair of diffraction gratings with respect to each of at least two wavelengths is integer times the associated wavelength. Further, peak portions and valley portions of the pair of diffraction gratings are chamfered.

### BACKGROUND OF THE INVENTION

1. Field of the Invention

The present invention relates to a diffractive optical element and an optical system having the same and, more particularly, to a diffractive optical element of such a grating structure that diffracts light (energy) of a plurality of wavelengths or a certain band so that the diffracted light concentrates on a particular order (design order), and an optical systems having the same.

2. Description of Related Art

One of the conventional methods of correcting the chromatic aberrations of the optical system is to combine a plurality of glasses (lenses) of different dispersions (Abbe numbers) from one another.

In addition to the above method of lessening the chromatic aberrations by using the combination of glass materials, there is another method of using a diffractive optical element having the diffracting function in the lens surface or the surface of other parts of the optical system, as disclosed in SPIE Vol. 1354 International Lens Design Conference (1990), Japanese Laid-Open Patent Applications No. Hei 4-213421 and No. Hei 6-324262, and U.S. Pat No. 5,044,706, etc.

This method is based on the physical phenomenon that, for the rays of light in the wavelengths other than a reference wavelength, the refractive surface and the diffractive surface in the optical system produce chromatic aberrations in opposite directions to each other.

Further, in such a diffractive optical element, when the period of its diffraction grating is made to vary depending on the place, the diffractive optical element can take an effect similar to an aspherical lens, giving a great advantage of reducing the aberrations of the optical system.

Here, on comparison in the refracting action of light, for the lens surface, one ray of light, even after being refracted, remains the one. For the diffraction grating, on the other hand, it is general that one ray of light, when diffracted, is divided into a plurality of rays of light of different diffraction orders.

To employ the diffractive optical element in the lens system, therefore, determination of the grating structure must be made such that, for a useful wavelength region, the light ray diffracts in concentration on a particular one order (design order). In a case where the energy of incident light concentrates on the diffracted light of the particular order, the intensities of the diffracted light rays of the other orders become low. If the sum of the intensities of the diffracted light rays of the other orders is zero, the diffracted light rays of the other orders are considered to be not present.

To this purpose, it becomes necessary that, for the design order, the light ray diffracts with a high enough efficiency (ideally, 100%). It should be also noted that, if the diffracted light of any of other orders than the design order is present, it forms an image at a different place from that of the design order, becoming flare.

In the optical system that utilizes the diffractive optical element, therefore, it is important to fully consider not only the spectral distribution of the diffraction efficiency for the design order, but also the behavior of the diffracted light of the other orders.

Suppose, as shown in FIG. 1, a diffractive optical element 1 is formed to a diffraction grating 3 in one layer on a substrate 2 or a surface in the optical system, then the diffraction efficiencies for particular orders are obtained as shown in FIG. 2. In the graph of FIG. 2, the abscissa represents the wavelength, and the ordinate represents the diffraction efficiency. This diffractive optical element is so designed that, for the diffracted light of the first order (shown by a solid line curve), the diffraction efficiency becomes highest in the useful wavelength region.

That is, the design order is the first order. In addition, there are also shown the diffraction efficiencies for diffraction orders near the design order, i.e., or zero order and second order ((1±1)st orders).

As shown in FIG. 2, in the design order, the diffraction efficiency has a highest value at a certain wavelength (540 nm) (hereinafter, referred to as the “design wavelength”), and gradually lowers as the wavelength goes away from the design wavelength. This lowering of the diffraction efficiency in the design order is reflected to the diffracted light of the other orders, thereby producing flare. Also, in a case where a plurality of diffractive optical elements are in use, it particularly results that the diffraction efficiency lowers in the wavelengths other than the design wavelength. This leads to a decrease in the transmittance of the entire optical system.

An arrangement for reducing this lowering of the diffraction efficiency is proposed in U.S. patent application Ser. No. 09/121,685 (Japanese Patent Application No. Hei 9-217103). FIG. 3 is a sectional view of the main parts of the diffractive optical element 1 proposed in U.S. patent application Ser. No. 09/121,685. The diffractive optical element 1 shown in FIG. 3 has a laminated cross-section form with two layers 4 and 5 of diffraction gratings on a substrate 2 in superimposed relation to each other. Then, the refractive indices and dispersion characteristics of the materials of the two layers 4 and 5 and their grating thicknesses are optimized to obtain higher diffraction efficiencies throughout the entire range of useful wavelengths.

In the type of diffractive optical element shown in FIG. 3, as the material of the diffraction grating for each layer, use may be made of easy-to-cut optical glasses, plastics, or optically transparent, ultraviolet curable polymer. In this case, however, it becomes difficult to take as large a difference in the refractive index as in the mono-layer type. Therefore, the large difference in the optical path length becomes harder to take. For this reason, the diffraction grating becomes considerably thick. For example, in the diffractive optical element 1 of the two-layer structure, the material used for the first layer 4 is assumed to be an ultraviolet curable polymer of refractive index nd=1.525 and Abbe number vd=47.8, and the material used for the second layer 5 is assumed to be another ultraviolet curable polymer of refractive index nd 1.635 and Abbe number vd=23.0. In this combination, the grating thicknesses are optimized. Then, the resultant diffraction efficiency is shown in FIG. 4. It is understandable that the diffraction efficiency of the first order is kept high over the entire visible spectrum. In this case, however, the first diffraction grating 4 has a thickness d1 of 12.70 μm, and the second diffraction grating 5 has a thickness d2 of 9.55 μm. On consideration of the usual one-layer diffraction grating whose thickness is about 1 μm, the two-layer diffraction grating has so much a large thickness. Also, in actual practice of manufacturing, because the second layer 5 shown in FIG. 3 is sectioned by every grating pitch, the use of the production technique by molding or the like results in a difficulty of transferring the form and detaching from the die.

### BRIEF SUMMARY OF THE INVENTION

An object of the present invention is to provide a diffractive optical element which is actually more practical to utilize than was heretofore possible. This utilizable diffractive optical element has such a fundamental structure that, as shown in FIG. 5, diffraction gratings 4 and 5 which differ in dispersion from each other are first formed in separation, then, both the diffraction gratings 4 and 5, while keeping their corresponding pitches to each other in alignment, are brought into a near juxtaposition, and through a certain space whose refractive index is “1” (for example, air), the diffraction gratings 4 and 5 are superimposed on each other.

Such diffraction gratings are manufactured by the ruling machine. So, the product can be used directly as the actual optical element. It may otherwise be used as a master grating, from which to produce replica gratings. In the former case, as the edge angle of the diffraction grating is more acute than that in the conventional or mono-layer type. If, as the diffractive optical element is made directly by ruling, the material is plastic or the like, there is a high possibility of chipping off the edges during ruling. In the latter case, when detaching the cast from the mold, the tip of the edge becomes dull or like phenomenon occurs, because the edge angle is so much acute.

Now, for the structure of the diffractive optical element as shown in FIG. 5, with the use of the brittle material described above, a form is considered that the first and second diffraction gratings 4 and 5 have their grating edges cut by 0.5 μm from the tip, as shown in FIG. 6. The diffraction efficiency obtained in this situation is shown in FIG. 7. In calculation, the grating pitch used is 70 μm. From the graph of FIG. 7, it is understood that the diffraction efficiency has lowered 3.5% or so over almost the entire visible spectrum. This lowering is reflected to the production of flare. In application to the diffractive optical element that has a pair of confronted diffraction gratings made of materials which differ in dispersion from each other, therefore, the diffraction efficiency for a particular diffraction order (design order) must be raised over the entire range of useful wavelengths. For this purpose, at least part of tips of a grating surface of one of the diffraction gratings and at least part of valleys, corresponding to the tips, of a grating surface of the other of the diffraction gratings are chamfered to a predetermined shape or formed to the predetermined shape (chamfered shape). Thus, the amount of flare can be reduced. In the following, including the claims, what is called the “chamfered” shape in the present specification includes the shape obtained by chamfering and the shape obtained by forming to the predetermined shape.

In accordance with an aspect of the invention, there is provided a diffractive optical element, which comprises a pair of diffraction gratings, the pair of diffraction gratings differing in dispersion from each other, the pair of diffraction gratings confronting each other through a space of a refractive index of 1, wherein a maximum optical path length difference occurring in the pair of diffraction gratings with respect to each of at least two wavelengths is integer times the associated wavelength.

In accordance with another aspect of the invention, there is provided a diffractive optical element, which comprises a pair of diffraction gratings, the pair of diffraction gratings differing in dispersion from each other, the pair of diffraction gratings confronting each other through a space of a refractive index of 1, wherein a maximum optical path length difference occurring in the pair of diffraction gratings with respect to each of at least two wavelengths is integer times the associated wavelength, and peak portions and valley portions of the pair of diffraction gratings are chamfered or formed in a chamfered shape.

In accordance with a further aspect of the invention, there is provided a diffractive optical element, which comprises a pair of diffraction gratings, the pair of diffraction gratings differing in dispersion from each other, wherein a maximum optical path length difference occurring in the pair of diffraction gratings with respect to each of at least two wavelengths is integer times the associated wavelength, and peak portions and valley portions of the pair of diffraction gratings are chamfered or formed in a chamfered shape.

In accordance with a further aspect of the invention, there is provided a diffractive optical element, which comprises a substrate, and a diffraction grating formed on the substrate, wherein either or both of peak portions and valley portions of the diffraction grating are chamfered or formed in a chamfered shape.

In the pair of diffraction gratings described above, there are embodiments, one of which is to divide the entire ruled surface into a plurality of zones, wherein the size and/or form of the chamfered portions is or are different with the different zones, and the other of which is not to differentiate this size or form.

A further embodiment is that the chamfered area has a form of a flat plane and, as the flat plane is projected onto the surface of the substrate on which the diffraction grating is formed, the length “a” of the flat plane in a direction of grating arrangement of a grating surface lies within the following range:

0.5 μm<a<2 μm

Another embodiment is that the chamfered area has a form of a curved surface and, as the curved surface is projected onto a flat plane made by a direction (line) of grating arrangement of a grating surface and a normal line of the substrate on which the diffraction grating is formed, a radius of curvature “r” of the curved surface lies within the following range:

0.5 μm<r<2 μm

An optical system according to the invention has a feature of using any one of the diffractive optical elements of the forms described above. As the optical system, mention may be made of an image forming optical system and an observation optical system.

The above and further objects and features of the invention will become apparent from the following detailed description of preferred embodiments thereof taken in conjunction with the accompanying drawings.

### BRIEF DESCRIPTION OF THE SEVERAL VIEWS OF THE DRAWING

FIG. 1 is a sectional view (saw-tooth wave form) of a conventional example of diffraction grating.

FIG. 2 is a graph of the diffraction efficiency of the conventional example shown in FIG. 1.

FIG. 3 is a sectional view of a conventional laminated-type diffractive optical element.

FIG. 4 is a graph of the diffraction efficiency of the conventional laminated-type diffractive optical element.

FIG. 5 is a sectional view showing the fundamental structure of a laminated-type diffractive optical element according to the invention.

FIG. 6 is a diagram for explaining a case where a manufacturing error has occurred in manufacturing the laminated-type diffractive optical element shown in FIG. 5.

FIG. 7 is a graph of the diffraction efficiency of the laminated-type diffraction grating in which the manufacturing error has occurred.

FIG. 8 is a front elevation view of the main parts of a diffractive optical element according to a first embodiment of the invention.

FIG. 9 is a sectional view of the main parts of the diffractive optical element according to the first embodiment of the invention.

FIG. 10 is a graph of the diffraction efficiency of the diffractive optical element according to the first embodiment of the invention.

FIG. 11 shows an example of modification of the diffractive optical element according to the first embodiment of the invention.

FIG. 12 is a fragmentary sectional view in enlarged scale of a modification of the diffractive optical element according to the first embodiment of the invention.

FIG. 13 is a front elevation view of the main parts of a diffractive optical element according to a second embodiment of the invention.

FIG. 14 is a longitudinal section view of an example of application of the diffractive optical element of the invention to a photographic optical system.

FIG. 15 is a longitudinal section view of another example of application of the diffractive optical element to an observation optical system.

### DETAILED DESCRIPTION OF THE INVENTION

Hereinafter, preferred embodiments of the invention will be described in detail with reference to the drawings.

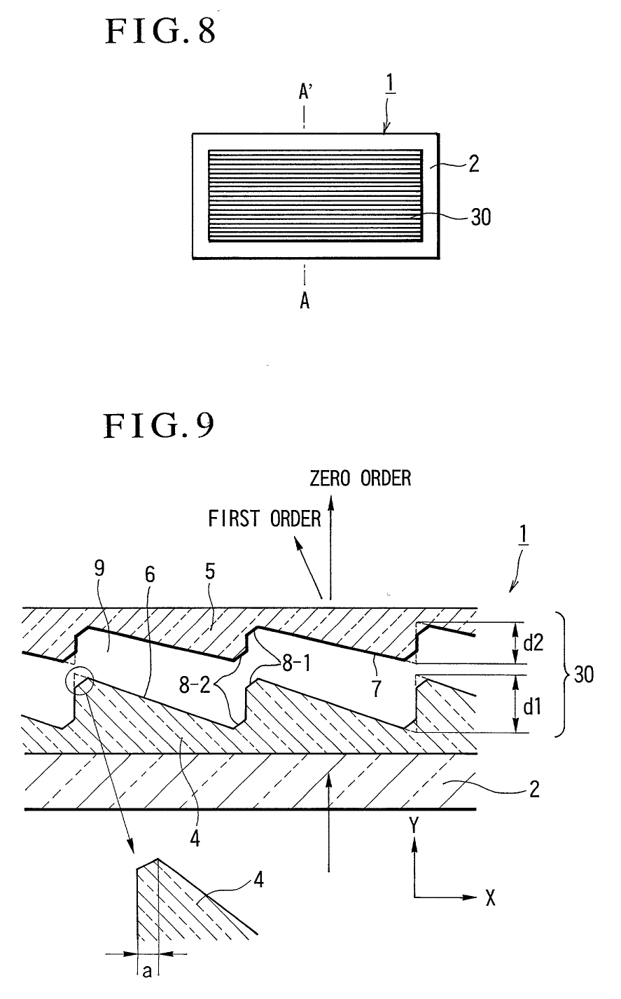

FIG. 8 is a front elevation view of a diffractive optical element according to a first embodiment of the invention. Referring to FIG. 8, the diffractive optical element 1 has such a structure that a multi-layer portion 30 which is composed of a plurality of layers (diffraction gratings) in superimposed relation in the direction perpendicular to the drawing paper of FIG. 8 is formed on the surface of a substrate 2. FIG. 9 is a fragmental cross-section view of the diffractive optical element 1 shown in FIG. 8 taken along A-A′ line of FIG. 8, with the diffraction gratings 4 and 5 illustrated as considerably deformed in the depth direction (in the vertical direction in the drawing paper).

For the diffractive optical element 1 according to the first embodiment, the profile of its diffraction grating comprises two layers, i.e., the first layer (first diffraction grating) 4 and the second layer (second diffraction grating) 5 formed on the substrate 2. At a boundary between the first layer 4 and an air layer 9, whose refractive index is 1, there is formed a first diffraction grating surface 6. At another boundary between the second layer 5 and the air layer 9, there is formed a second diffraction grating surface 7.

The diffractive optical element 1 shown in FIG. 9 is provided with chamfered portions 8-1 and 8-2 at the peak portions and valley portions of each of the diffraction gratings 4 and 5, in which edge portions thereof confront each other. Further, all the layers act as one diffractive optical element 1.

In such a manner, the diffractive optical element according to the first embodiment is constructed with a pair of diffraction gratings whose materials are different in dispersion from each other on the substrate in superimposed relation with their diffraction grating surfaces confronting each other through the air layer. With this arrangement, the chamfered portions 8-1 and 8-2 are formed at the peak portions and valley portions of the diffractive optical surface 6 of the one diffraction grating 4 and the corresponding valley portions and peak portions of the diffraction grating surface 7 of the other diffraction grating 5. For the diffractive optical element 1, the visible light is selected as the useful wavelengths, and the first order of diffraction is used as the particular diffraction order. To increase the diffraction efficiency for the first order over the entire range of visible spectrum, determination is made of the design wavelengths and the materials for the diffraction gratings 4 and 5. Also, the amount and shape of chamfering are determined so as to reduce flare to a desired amount.

Next, the diffraction efficiency of the diffractive optical element according to the first embodiment is described.

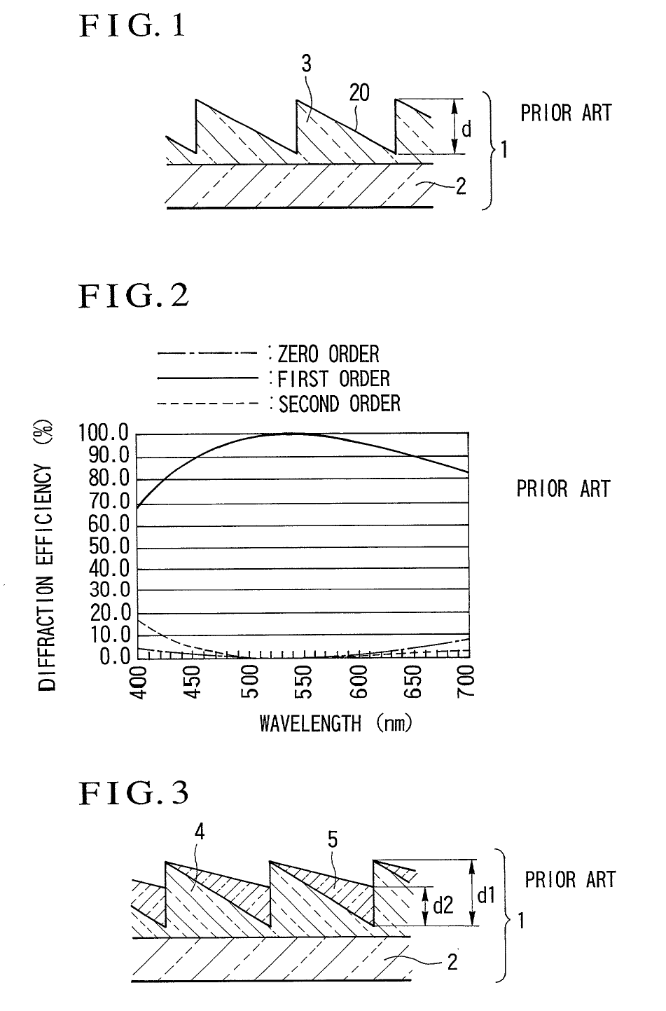

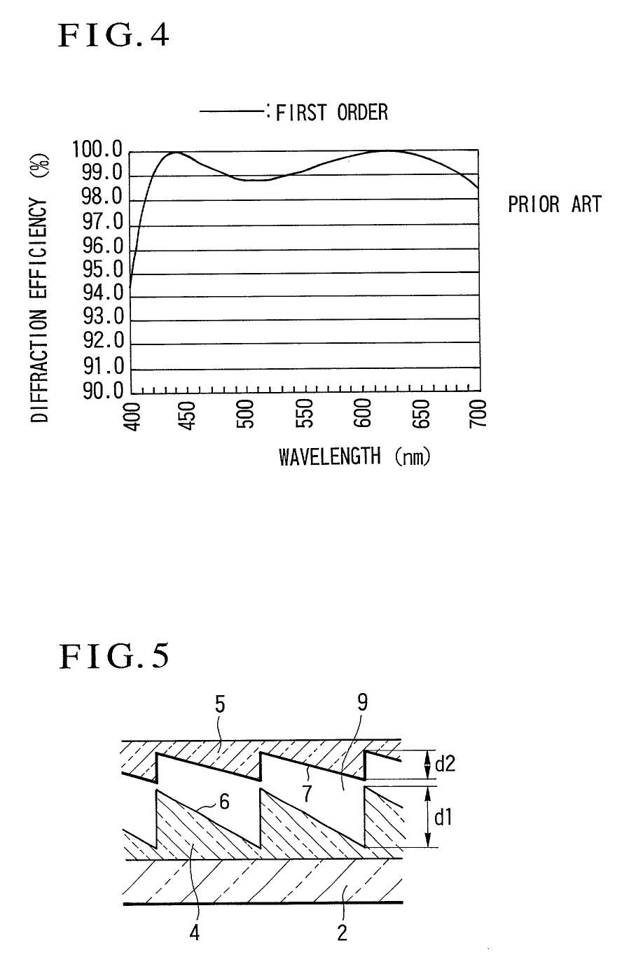

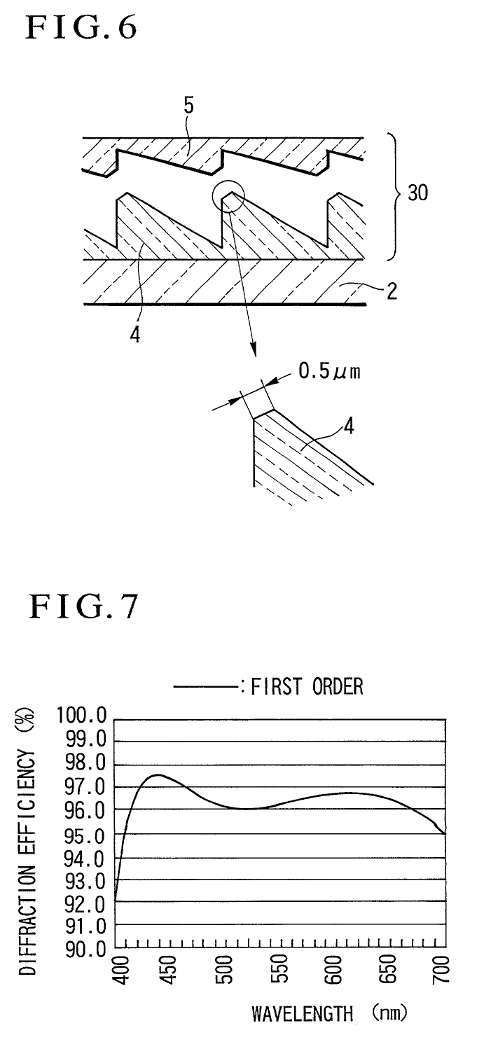

In the usual one-layer transmission-type diffraction grating 3 which is used in the air, as shown in FIG. 1, the diffraction efficiency at a design wavelength λ0 is highest under the condition that, as light rays enter the diffraction grating 3 at right angles, the optical path length difference d0 between the peak and valley of the diffraction grating surface 20 is integer times the design wavelength λ0. Since the refractive index of the air is 1, the following expression is obtained:

d0=(n0−1)d=mλ0 (1)

where λ0 is the refractive index for the design wavelength λ0 of the material of the diffraction grating 3, d is the grating thickness, and m is the diffraction order.

Even for the diffractive optical element, according to the first embodiment of the invention, which has two or more layers of diffraction gratings, the basic concept is the same. To make all the layers to function as one diffraction grating of high diffraction efficiency, for each of at least two wavelengths, the optical path length differences between the peaks and valleys of the diffraction grating surfaces formed at boundaries between the layers are obtained, and the sum obtained by adding together the optical path length differences over the all layers is determined to become integer times the associated wavelength.

Therefore, since the refractive index of the air is 1, the condition in the case of the first embodiment shown in FIG. 5 or FIG. 9 becomes as expressed below:

(n01−1)d1−(n02−1)d2−mλ0 (2)

where n01 and n02 are the refractive indices for the wavelength λ0 of the materials of the first and second layers 4 and 5, respectively, and d1 and d2 are the grating thicknesses of the first and second diffraction gratings (the first and second layers) 4 and 5, respectively.

Here, the diffracting direction is taken into account. Assuming that, in FIG. 9, the diffracted light to the left side of that of zero order is of positive order, then any layer in the equation (2) must be given either of plus and minus signs. For a grating shape with the thickness decreasing in a direction from the left to the right as viewed in FIG. 9, or for the first layer 4, the sign to be used is positive. Conversely, when the thickness increases in the direction from the left to the right, or for another grating shape as in the second layer 5, the sign to be used is negative. It is also to be noted that the grating thickness is measured in such an ideal form that no chamfering is done at the portions 8-1 and 8-2, leaving the grating edge at an acute angle.

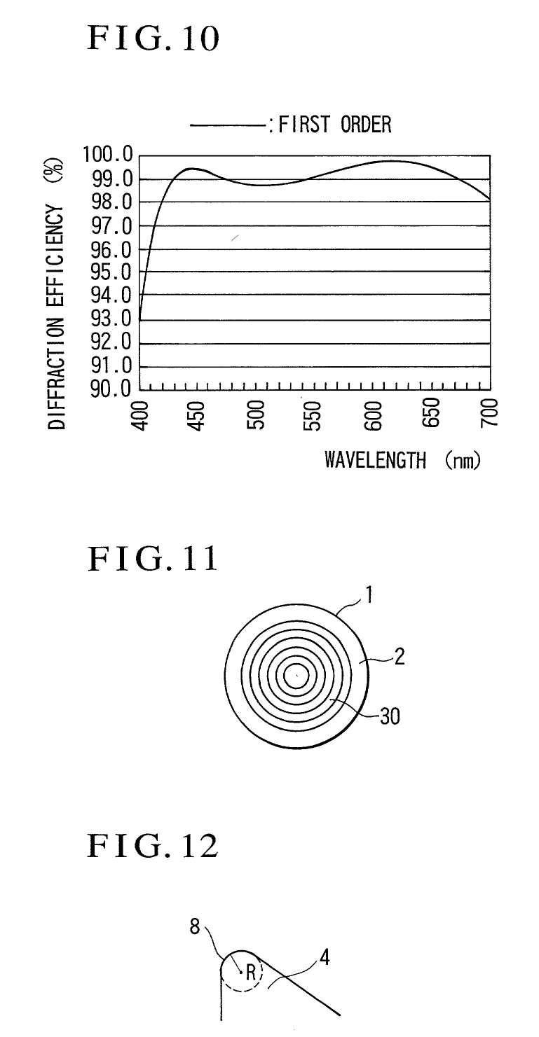

Next, the effect of the chamfered portions formed in the edge portions of the diffraction grating surface in the first embodiment is described below. As the laminated-type diffractive optical element in the first embodiment, an example is taken of the two-layer structure shown in FIG. 9. Here, the material used for the first layer 4 is an ultraviolet setting resin of refractive index nd=1.525 and Abbe number νd=47.8. Another ultraviolet setting resin which has a refractive index nd=1.635 and an Abbe number νd=23.0 is used for the second layer 5. The grating pitch is 70 μm. All the edges of the diffraction grating surfaces are chamfered to a flat plane by an amount of 0.5 μm. The diffraction efficiency obtained in this instance is shown in FIG. 10. As is understandable from FIG. 10, although the diffraction efficiency has deteriorated 1% from that of the ideal form at shorter wavelengths than 440 nm, the lowering is reduced to 0.3% throughout almost the entire range of visible spectrum. As compared with the case where some of the edges are accidentally dulled, or the graph of FIG. 7 where the lowering is 3.5%, therefore, the amount of flare, too, is suppressed to 1/10, thus improving the performance.

It should be pointed out that, in the first embodiment, if the chamfering is too much small, the breaking of the tip and the transferability cannot be improved. If too much large, an unduly large deterioration of the diffraction efficiency results. Therefore, it is preferred that the chamfered amount in terms of the projected length “a” of the chamfered flat area on the substrate 2 in a direction X of grating arrangement of the diffraction grating surface lies within the following range:

0.5 μm<a<2 μm

Although the foregoing discussion has been made as limited to the shape of one period (grating element) of the diffraction grating, the same conclusion can be applied even to the entirety (all the periods) of the diffraction grating.

Also, since the period (pitch) of the diffraction grating does not affect the diffraction efficiency, the principle of the first embodiment is applicable not only to the one-dimensional isopitch type of diffraction grating shown in FIG. 8, but also to diffractive optical elements having diffraction gratings in a wide variety of forms such as a diffractive optical lens having a zonal type diffraction grating with the pitch progressively changing toward the margin like that shown in FIG. 11.

Also, in the first embodiment, the chamfered form has been in the flat plane. However, the chamfered form is not limited to the flat plane. For example, the chamfered form may otherwise be such a curved surface that, when projected to a plane (X-Y plane) defined by the X direction of grating arrangement of the grating surface and a Y direction in the normal to the substrate, it becomes a curved line as shown in FIG. 12. That is, a round form in the X-Y plane may be used with a minute radius of curvature R. In this case, too, it is preferred that the same as the above-described chamfered amount for the flat plane applies to the radius R of the curved surface, lying in the following range:

0.5 μm<R<2 μm

Also, although the first embodiment has been described in connection with the flat plate as the substrate 2 on which to put a plurality of diffraction gratings in superimposed relation when making the diffractive optical element, the plurality of diffraction gratings of laminated structure may otherwise be put on the surface of a lens or like curved surface. Even in this case, similar results are attained.

Also, although the first embodiment has been described in connection with the first order of diffraction, the invention is not confined to the first order, but applicable to the second order or a predetermined one of any other orders than the first order. Even for another order, the same improved results are attained provided that the overall optical path length difference with the diffracted light of a desired order becomes the same as a desired design wavelength.

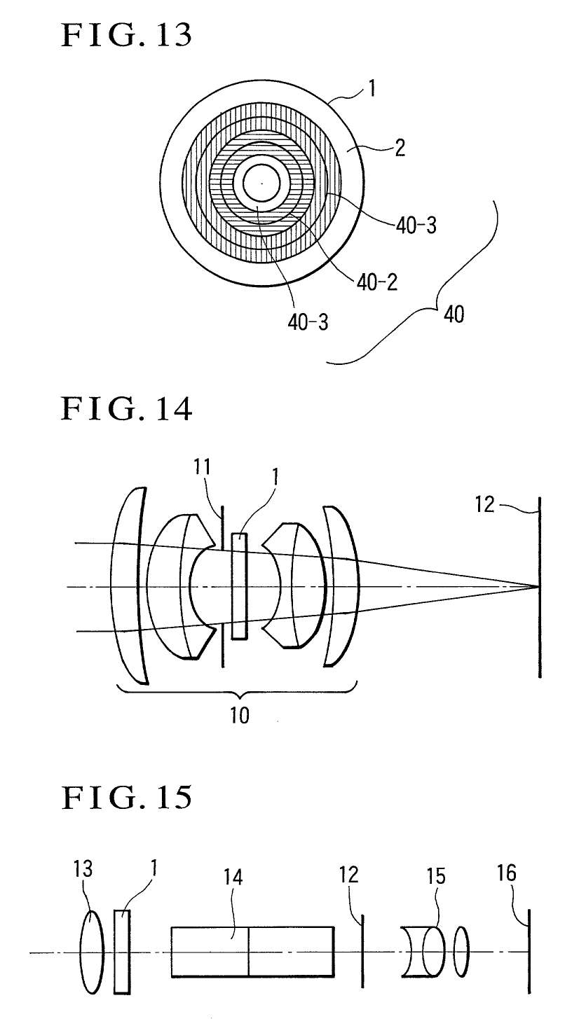

FIG. 13 is a front elevation view of the main parts of a diffractive optical element according to a second embodiment of the invention.

In the second embodiment, the diffractive optical element 40 is divided into a plurality of areas 40-1, 40-2 and 40-3. Of the plurality of areas 40-1, 40-2 and 40-3, at least one area is given the above-described chamfering. If a plurality of areas are given the above-described chamfering in the second embodiment, these areas are made different from each other in the chamfered form of the edges. Specifically speaking, in a case where the diffractive optical element also serves as a lens like that shown in FIG. 13, the grating pitch becomes progressively smaller as going from the center to the margin. Along with this, the angle of the grating edge becomes progressively acuter toward the margin. Therefore, the marginal area 40-3 are chamfered to a rather large amount. The chamfered amount of the intermediate area 40-2 is made smaller than that of the marginal area 40-3. The paraxial area 40-1 is, because the edges have much dull an angle, either lessened in the chamfered amount from that of the area 40-2, or not chamfered at all as the case may be. In such a manner, the chamfered amount and/or the chamfered form is made to vary with variation of the edge angle. Accordingly, the lowering of the diffraction efficiency can be suppressed as far as possible, and the manufacturing, too, is made easier to produce the diffractive optical element.

FIG. 14 is a schematic diagram of an optical system using the diffractive optical element of the invention. This optical system is used for photography with camera or the like. In FIG. 14, a photographic lens 10 contains a lens assembly, a diaphragm 11 and the diffractive optical element 1 in the interior thereof. At a focal plane 12, there is film or a CCD.

By using the diffractive optical element of the invention, the wavelength-dependent property of the diffraction efficiency is remarkably improved. Therefore, the flare is reduced and the resolving power in the low frequencies is increased, so that a photographic lens of high performance is thus achieved. Since the diffractive optical element of the invention is amenable to the low-cost production techniques, it is also made possible to provide an objective which is excellent in productivity and inexpensive in a sense of the photographic lens.

In FIG. 14, the diffractive optical element 1 of the invention is provided on a flat parallel glass plate adjacent to the diaphragm 11. However, the invention is not confined thereto. The diffractive optical element 1 may otherwise be provided on the curved surface of any lens element, or may be plural in number to use.

Also, the second embodiment has been illustrated in view of its application to a photographic lens of a camera. However, the invention is not confined thereto and is applicable to the taking lenses for video cameras, or the reader lenses for image scanners or digital copiers in office machines. Even in such variations, similar improved results are attained.

FIG. 15 is a schematic diagram of another type of an optical system using the diffractive optical element of the invention. This type is assumed to be an observation optical system such as a binocular. In FIG. 15, an objective lens 13, an image inverting prism 14 for erecting the image, an eyepiece lens 15 constitute either side of the binocular. Reference numeral 16 denotes an evaluation plane (pupil plane).

In FIG. 15, the diffractive optical element is denoted by reference numeral 1. The diffractive optical element 1 is formed with an aim to correct chromatic aberrations at an image plane 12 of the objective lens 13.

By using the diffractive optical element of the invention, the wavelength-dependent property of the diffraction efficiency is remarkably improved. Therefore, the flare is reduced and the resolving power in the low frequencies is increased, so that an objective lens of high performance is thus achieved. Since the diffractive optical element of the invention is amenable to the low-cost production techniques, it is also made possible to provide an objective which is excellent in productivity and inexpensive in a sense of the observation optical system.

The present embodiment has been illustrated with the diffractive optical element 1 positioned just behind the objective lens 13, but the invention is not confined thereto. It may take its place on the surface of the prism or in the interior of the eyepiece lens 15. Even in these variations, similar results are attained. It is to be noted in this connection that the diffractive optical element on the object side of the image plane 12 has an effect of reducing chromatic aberrations in the objective 13 alone. In the case of the observation optical system for the naked eye, it is, therefore, desired that the diffractive optical element takes its place at least on that side which includes the objective lens 13.

Also, although the present embodiment has been described with the use of the diffractive optical element of the invention in the binocular, the usage of this diffractive optical element is not confined thereto, but may be to terrestrial or astronomical telescopes and also to optical finders for the leaf shutter type cameras or video cameras. Even in these variations, similar results are attained.

According to the foregoing embodiments, a diffractive optical element which is amenable to economic production techniques while still keeping a high diffraction efficiency and which is capable of suppressing the flare, and an optical system having the diffractive optical element can be achieved.

Since the grating edges of each diffraction grating can be made dull in angle by chamfering them, the shape tolerance is greatly improved in ruling the diffraction grating. When forming the diffraction grating by the molding technique, the accuracy and reliability with which the shape of the edge of the master diffraction grating is transferred to the cast is also greatly improved. As a result, a diffractive optical element which is stable in shape and, therefore, good in performance is obtained. For this reason, even when the diffractive optical element is incorporated in the optical system, the diffraction efficiency can be kept high. It is, therefore, made to provide an optical system which can suppress the amount of flare light to a minimum.

Further, by changing the chamfered amount of the edges of the diffraction gratings by every area of the diffractive optical element, the lowering of the diffraction efficiency can be suppressed to a maximum. When used in the optical system, the diffractive optical element can keep the high diffraction efficiency, which in turn suppresses flare.

Moreover, the technique of chamfering the peak portions and valley portions of the diffraction grating is applicable to such diffractive optical elements as shown in FIGS. 1 and 3.

1. A diffractive optical element, comprising:
a pair of diffraction gratings, said pair of diffraction gratings differing in dispersion from each other, said pair of diffraction gratings confronting each other through a space of a refractive index of 1,
wherein a maximum optical path length difference occurring in said pair of diffraction gratings with respect to each of at least two wavelengths is integer times the associated wavelength.

2. A diffractive optical element comprising:
a pair of diffraction gratings, said pair of diffraction gratings differing in dispersion from each other, said pair of diffraction gratings confronting each other through a space of a refractive index of 1,
wherein a maximum optical path length difference occurring in said pair of diffraction gratings with respect to each of at least two wavelengths is integer times the associated wavelength, and peak portions and valley portions of said pair of diffraction gratings are chamfered.

3. A diffractive optical element, comprising:
a pair of diffraction gratings, said pair of diffraction gratings differing in dispersion from each other,
wherein a maximum optical path length difference occurring in said pair of diffraction gratings with respect to each of at least two wavelengths is integer times the associated wavelength, and peak portions and valley portions of said pair of diffraction gratings are chamfered.

4. A diffractive optical element, comprising:
a substrate; and
a diffraction grating formed on said substrate, wherein either or both of peak portions and valley portions of said diffraction grating are chamfered.

5. A diffractive optical element, comprising:
a pair of diffraction gratings, said pair of diffraction gratings differing in dispersion from each other, said pair of diffraction gratings confronting each other through a space of a refractive index of 1, wherein a maximum optical path length difference occurring in said pair of diffraction gratings with respect to each of at least two wavelengths is integer times the associated wavelength, and peak portions and valley portions of said pair of diffraction gratings are formed in a chamfered shape.

6. A diffractive optical element, comprising:
a pair of diffraction gratings, said pair of diffraction gratings differing in dispersion from each other,
wherein a maximum optical path length difference occurring in said pair of diffraction gratings with respect to each of at least two wavelengths is integer times the associated wavelength, and peak portions and valley portions of said pair of diffraction gratings are formed in a chamfered shape.

7. A diffractive optical element, comprising:
a substrate; and
a diffraction grating formed on said substrate, wherein either or both of peak portions and valley portions of said diffraction grating are formed in a chamfered shape.

8. An optical system, comprising:
a diffractive optical element according to one of claims 1 to 7; and
a lens system.
